(19) United States
(12) Patent Application Publication
(10) Pub. No.: US 2015/0377549 A1
(43) Pub. Date: Dec. 31, 2015

(54) FISHING APPARATUS WITH POWER UNIT

(71) Applicant: GREENLUC LLC, Pearland, TX (US)

(72) Inventors: YI CAI, Houston, TX (US); Mike McAlister, Pearland, TX (US); Will Jasso, Houston, TX (US); Jason Rivera, Houston, TX (US)

(73) Assignee: GREENLUC, LLC, Pearland, TX (US)

(21) Appl. No.: 14/316,682

(22) Filed: Jun. 26, 2014

(51) Int. Cl. F25D 27/00; A01K 97/10; F25D 3/06; A01K 97/05

(52) U.S. Cl. CPC F25D 27/00; A01K 97/05; A01K 97/10; F25D 3/06

(57) ABSTRACT

The present invention relates to an apparatus for fishing, wherein said apparatus includes a main body, a collapsing bar, and at least one lighting unit. Said main body further comprises an ice chest, a tackle box, a bait bucket and a power unit. An aerator is provided to the bait bucket wherein it is powered by the power unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

1. Filed of the Invention

This invention relates to a fishing gear having a main body, a collapsing bar and at least one lighting unit, wherein the main body includes an ice chest, a tackle box and a bait bucket. More specifically, this invention relates to the fishing gear having the lighting unit and an aerator provided to the bait bucket, both are powered by a power unit.

2. Description of Prior Art

A variety of prior art has been developed to accommodate a fisherman's needs for a portable and multifunctional cooling container. For example, U.S. Pat. No. 6,467,779 discloses a combination of an ice cooler and fishing rod holders for use when fishing, wherein a plurality of the fishing rod holders are provided to side portions of the ice cooler.

U.S. Pat. No. 7,415,794 discloses a combination of a portable cooler and a tackle box, wherein a plurality of trays, pockets and pouches may be provided to the combination for storing purpose, and at least one wheel and at least one handle affixed to the combination are provided for transportation.

U.S. Pat. No. 8,256,156 discloses a portable angler cooler apparatus includes two skis removable connected to its wheels. Said apparatus comprises a first compartment adapted to store food and drink, a second compartment adapted to store ice and fish, and a third compartment including an air hose for aerating water adapted to hold baits and water.

Giving the sheer amount of stuffs the fisherman may carry, there is a need to combine all the gears, including the cooler, the tackle box, the rod holder and a bait bucket, in a portable device therefore simplifying the preparation and transportation for a fishing trip.

There is also a need to include additional functions onto said portable device, so that the fisherman and the portable device may be suitable for day and night fishing with extended fishing hours.

### BRIEF SUMMARY OF THE INVENTION

According to one embodiment, the present invention is an apparatus for fishing, including a main body, a collapsing bar and at least one lighting unit. Accordingly, the main body includes an ice chest, a tackle box, a bait bucket, and a power unit. Preferably, the main body is provided with at least one wheel for mobility.

The main body is provided with a cover pivotally connected thereto. In a preferred embodiment, the cover is provided with at least one window that accesses to the ice chest, the tackle box, and/or the bait bucket. The cover also provides sealing to parts indentified herein.

In another embodiment of the present invention, the bait bucket includes an aerator that is powered by the power unit.

In another embodiment of the present invention, at least one rod holder is mounted to the main body.

In yet another embodiment of the present invention, the collapsing bar may be collapsible and removable. A lower end of said collapsing bar is mounted to the main body, and a upper end of said collapsing bar is affixed with at least one lighting unit.

In yet another embodiment of the present invention, the power unit consists of a power source, an inlet, a power panel, and at least one outlet. The power unit powers both the aerator and the lighting units. Preferably, the outlets may include a USB outlet.

In yet another embodiment of the present invention, the lighting units may be bright light sources such as LED and/or HID (high intensity discharge). Preferably, the light sources consist of spot lights, flood lights, or both. Even more preferably, the lighting units are provided with rotation mechanisms so that lights therefrom may be delivered to any desired directions or angles.

An object of the present invention is to provide a portable apparatus for carrying foods/drinks, fishing gears, and baits, all of which are needed for a fishing trip.

Yet another object of the present invention is to provide the apparatus for holding fish rods during transportation and/or fishing.

Yet another object of the present invention is to provide the apparatus that is equipped with the bait bucket having the aerator for holding living baits for fishing.

Yet another object of the present invention is to provide the apparatus including the lighting units that attracts fishes.

Yet another object of the present invention is to provide the apparatus including the power unit that may power the aerator and the lighting units. More preferably, said power unit is provided with the inlet and the outlets, therefore said power unit may be recharged through the inlet, and provide power to other devices through the outlets. In a preferred embodiment, the power unit is provided with an interface indicating its status.

Yet another object of the present invention is to provide the apparatus that allows multiple functions other than those described hereabove. The configuration of the device may allow the fisherman to rest thereon. Said device also provides quick access to stuffs carried within the container through the cover or the windows. More specifically, the cover also serves as operating platform for operations such as fish cutting.

It is noted that the foregoing descriptions discloses the most important features of the present invention. There are additional features of the present invention, as well as the most important ones, will be described herein after. The foregoing descriptions are neither intended to define the present invention nor are they invented to be limiting as to the scope of the present invention.

### BRIEF DESCRIPTION OF THE SEVERAL VIEWS OF THE DRAWINGS

The drawings described herein are for illustrating purposes only of selected embodiments and not all possible implementation and are not intended to limit the scope of the present disclosure.

FIG. 1 is a perspective view of one embodiment of the present invention.

FIG. 2 is a perspective view of a main body of FIG. 1.

FIG. 3 is yet another perspective view of the main body of FIG. 1.

FIGS. 4 & 5 are yet other perspective views of FIG. 1 showing different status of a collapsing bar and lighting devices.

FIG. 6 is a perspective view of one embodiment of the present invention having the lighting devices.

FIGS. 7A&B are perspective views of yet another embodiment of the present invention having the lighting devices.

### DETAILED DESCRIPTION OF THE INVENTION

The detailed description of the present invention is considered as illustrative only of the principles of the invention. It does not serve in any way to limit the invention to the exact construction and operation shown as described.

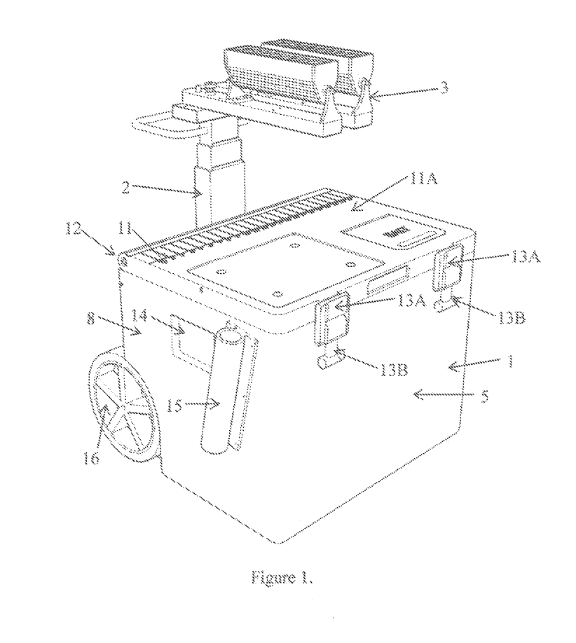

The present invention relates to an apparatus of fishing gears. As shown in FIG. 1, said apparatus consists of a main body 1, a collapsing bar 2, and at least one lighting unit 3, wherein a lower end of the collapsing bar is mounted on the main body, and an upper end of it is affixed with the lighting units.

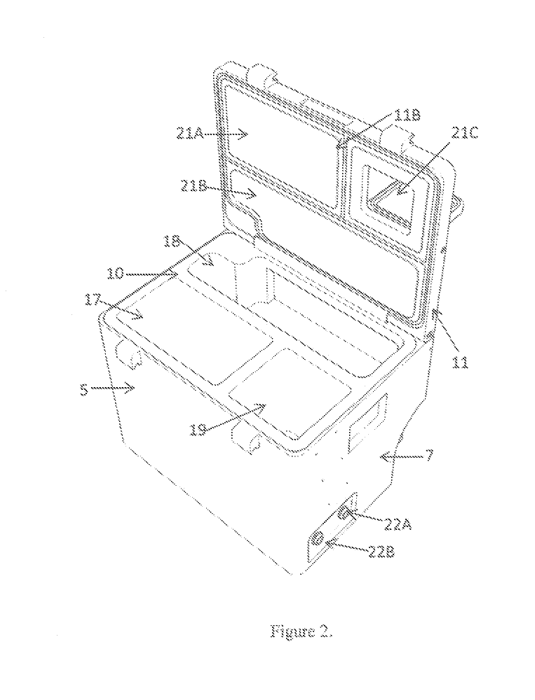

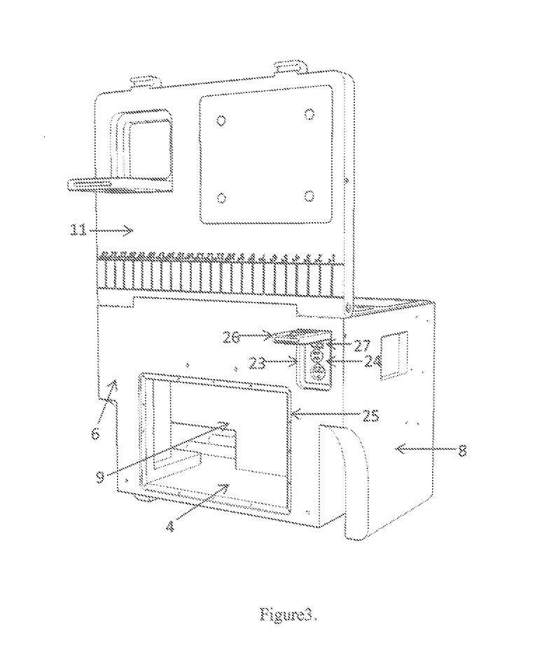

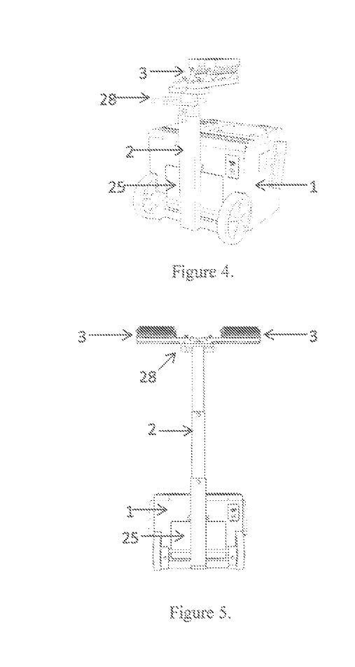

FIGS. 2-5 show the main body according to one embodiment of the present invention. The main body comprises of a bottom wall 4, a front wall 5, a back wall 6, and first and second side walls 7&8, wherein the walls define an inner space 9 and an upper surface 10. A cover 11 pivotally connects to top of the back wall at pivotal attachment 12 and a rear end of the cover. Latches and compartments 13A&B are provide to the top of the front wall and a front end of the cover, wherein said latches and the compartments 13A&B may lock the cover to the front wall. Other locking mechanisms known to those skilled in the art may also be provided.

The walls and cover all have their individual thicknesses, and may be made of materials known to those skilled in the art to provide structural supporting, protecting, and/or insulating to contents to be installed or placed in the inner space.

In some embodiments of the present invention, handling mechanisms 14 are provided to the walls of the main body to facilitate transportation of the apparatus. Said mechanisms could be handlings, or as shown in the figures, recesses to the walls.

At least one rod holder 15 is provided to the apparatus. The rod holder functions to hold rods during fishing and/or transporting. It could come in any form that known to those skilled in the arts. For example, it could be a tube-like device having one end open where a rod may be inserted therein. The rode holders may be mounted to any wall of the main body. However, they are preferably mounted to the side walls with an inclined angle.

The main body may further include wheels 16 to facilitate its transportation. For example, one wheel is provided to each of the side walls, wherein said wheels are rotatable installed to wheeling recesses of said walls.

Preferably, the cover has a continued flat exterior 11A. Said exterior may be used as cutting board during fishing activities. Therefore the exterior of the cover is preferably made of, or covered with materials that providing relative hardness and water-resistance, and are easily cleaned. The exterior may further printed with a ruler across its width or length, so that fishes may be measured thereon. The cover as well as the main body, may also function as a stool for fishman, so that the fishman may sit on the main body during fishing.

Referring to FIGS. 2&3, the main body further includes an ice chest 17, a tackle ox 18, a bait bucket 19, and a power unit 20, all of which are installed within the inner space. It is to be noticed that the names of individual parts described herein are for identifying purpose only and do not serve as restriction to their structures and/or functions.

The ice chest, the tackle box and the bait bucket all have their openings at the upper surface 10. In some of the embodiments of the present invention, the cover 11 is further provided with windows 21A, B &C to the ice chest, the tackle box and/or the bait bucket, respectively. Preferably, said windows 21 may be pivotally connected to the cover. Locking mechanisms and/or handling mechanisms for conveniently lifting said openings may also be provided at individual bases. The windows may or may not be shaped according to the opening underneath, i.e., of the ice chest, the tackle box and the bait bucket. Said windows offer direct accesses to the underneath openings without lifting the cover.

Sealing elements are provided to an interior 11B of the cover and/or the windows coupling the edges of the upper surface 10 or the openings identified immediately above. Said sealing elements may be made of soft and flexible, or relatively hard materials known to those skilled in the art. The sealing elements function in sealing the respective parts, prevent their contents from leaking out, and/or providing insulation. It is especially true for the ice chest and the bait bucket, since the two may typically contain liquids. Therefore, a water-tight sealing is essential for preventing the liquids from spilling over during usage.

The ice chest 17 and the bait bucket 19 are provided with their drainages 22A&B, respectively. The drainages 22 may be placed close to or on the bottom wall of the main body to achieve the best and most convenient draining effects. For example, the drainages are placed at a recess at bottom of one of the side walls.

The bait bucket 19 may further include an aerator powered by the power units.

The power unit consists of a power source, a power panel 23, and power outlets 24. The power source may be any device that provides electric power. For example, a battery. The power source is installed in the inner space and relatively close to the bottom and the back the main body. For example, it is installed relatively underneath of the bait bucket 19. Accordingly, a back opening 25 is provided at the back wall of the main body, so that the power source may be accessed thereby, and removed therefrom. A back lid is also provided to cover said back opening.

The power panel 23 may be installed on any wall or cover of the main body. For example, said panel is installed on the back wall close to the cover. The panel is operationally equipped with a lid 26 pivotally connected to top of the panel. Preferably, the panel lid may seal the panel and protect it from outside environments such as moisture. Preferably, the panel provides an indicator 27 showing status of the power unit. For example, an LED indicator that shows remaining power of the battery.

In some embodiments, the power panel may be incorporated with the power outlets. The outlets are able to provide power to devices other than the aerator and the lighting unit of the apparatus. For example, the outlets could be USB outlets capable of providing power to electronic devices such as cell phones or ipads.

In one embodiment of the present invention, an inlet may be provided to the power unit to re-charge the power source, and/or to provide power directly to the outlets and others units of the apparatus.

Alternatively, the power unit may be recharged using solar source.

The collapsing bar 2 is mounted to the main body, for example, on its back wall. Preferably, said bar is removable so that the back opening 25 and its back lid lid may be exposed. Even more preferably, a pulling handle 28 is pivotally provided close to the upper end of the bar, allowing the fishman to pull the apparatus for transportation.

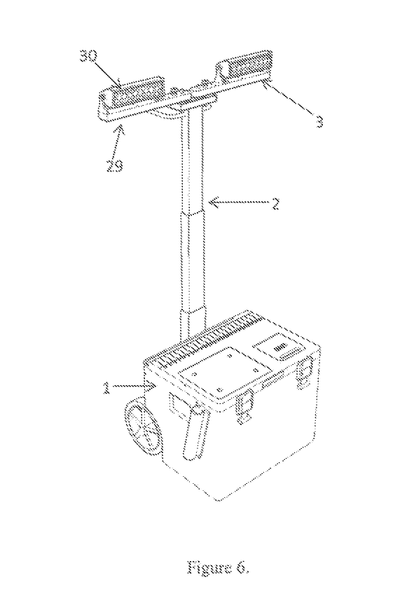

At least one lighting unit is mounted to the collapsing bar. FIG. 6 shows one embodiment of the present invention which has two lighting units mounted. Each lighting unit consists of a horizontal bar 29 and a lighting device 30.

The horizontal bar is pivotally mounted to the upper end of the collapsing bar. For example, the horizontal bar is mounted on the collapsing bar through a pin. Said bar may pivot around the pin for 360°. The horizontal bar may also be collapsible so that its length may be extended horizontally.

The lighting device may be any light sources known to those skilled in the art. For example, LED lights equal to or greater than 7500 lumens per unit, or equal to or greater than 15000 lumens per unit. The lighting device may be pivotally fixed to the horizontal bar, for example, through a set of brackets, so that said device is able to rotate amend an axis that is parallel to the longitudinal axis of the horizontal bar. Therefore, the lighting unit is able to provide lights to any direction from the apparatus.

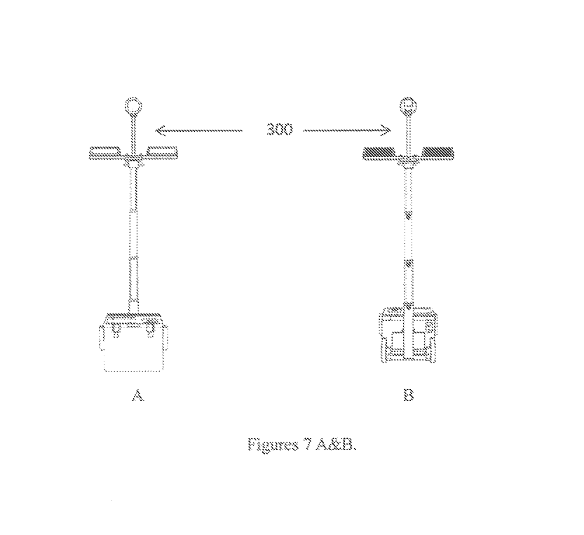

FIGS. 7 A&B showing yet another embodiment of the present invention, wherein a third lighting unit 300 is provided thereto. Preferably, the third lighting unit 300 may include any light sources such as HID. The third lighting unit 300 is preferably rotatable through mechanisms known to those skilled in the art thus may be pointed at any direction if desired.

Accordingly, the lighting units may provide pointing or flooding lights for fishing. Even more preferably, the two types of the lights may be provided by combinations of different types of the lighting devices.

With respect to the description hereabove, it is to be noticed that the optimum dimensional relationships, the sizes, the shapes and the materials for parts of the apparatus, including the ice chest, the tackle box, the bait bucket, the power unit, the lights units and the collapsing bar, are readily apparent to those skilled in the art, and all equivalent to the descriptions hereabove are intended to be encompassed by the present invention. Therefore, all suitable modifications and equivalents may be resorted to, falling within the scope of the present invention.

We claim:

1. An apparatus for fishing, comprising:
a main body, wherein said main body includes a bait bucket with an aerator and a power unit; and,
at least one lighting device.

2. The apparatus of claim 1, wherein an ice chest is provided to the main body.

3. The apparatus of claim 1, wherein an ice chest and a tackle box are provided to the main body.

4. The power unit of claim 1, wherein said power unit is provided with an inlet, and at least one outlet.

5. The power units of claim 4, wherein it is recharged by a solar source.

6. The power unit of claim 1, wherein said power unit is provided with an indicator.

7. The apparatus of claim 1, further comprising a cover pivotally connected to the main body, wherein at least one window is provided to the cover.

6. The apparatus of claim 1, further comprising a ruler printed on a cover pivotally connected to the main body.

7. The lighting device of claim 1, wherein said device is pivotally mounted to a horizontal bar and said bar is pivotally mounted to the apparatus.

8. The lighting device of claim 1, wherein said device may be rotatable.
